(19) United States
(12) Patent Application Publication
(10) Pub. No.: US 2025/0244571 A1
(43) Pub. Date: Jul. 31, 2025

(54) METHOD AND SYSTEM TO FINE-TUNE EXTRINSIC PARAMETERS OF A FISHEYE LENS APPLIED TO SURROUND-VIEW STITCHING

(71) Applicant: VIA TECHNOLOGIES, INC., New Taipei City (TW)

(72) Inventors: Fan DONG, Beijing (CN); Chao-Chin CHANG, New Taipei City (TW)

(21) Appl. No.: 19/004,820

(22) Filed: Dec. 30, 2024

(30) Foreign Application Priority Data
Jan. 26, 2024 (CN) 202410115572.8

(51) Int. Cl. G02B 27/00; G01M 11/02; G02B 13/06; G03B 43/00

(52) U.S. Cl. CPC G02B 27/0012; G01M 11/0264; G02B 13/06; G03B 43/00

(57) ABSTRACT

A method to fine-tune extrinsic parameters of a fisheye lens applied to surround view splicing is provided. Fisheye images are obtained from multiple fisheye lenses. Both sides of the fisheye images contain calibration boards. Initial extrinsic parameters are obtained based on the fisheye images. Multiple corner points of the calibration boards in the fisheye images are detected. The corner points are arranged so that the corner points are connected into a quadrilateral in sequence. The initial extrinsic parameters are multiplied by a fine-tuning value to obtain intermediate extrinsic parameters. The corner points are projected to a top-view projection by using the intermediate extrinsic parameters. The intermediate extrinsic parameters are adjusted according to the shape, size, and overlapping effect of the area surrounded by the corner points in the top-view projection.

### CROSS REFERENCE TO RELATED APPLICATIONS

This Application claims priority of China Application No. 202410115572.8, filed on Jan. 26, 2024, the entirety of which are incorporated by reference herein.

### BACKGROUND OF THE INVENTION

### Field of the Invention

The present invention relates to computer vision image processing, and, in particular, to a method to fine-tune extrinsic parameters of a fisheye lens applied to surround-view stitching.

### Description of the Related Art

Although current fisheye lens calibration approaches have improved accuracy and convenience, it still has some limitations and shortcomings. For instance, it requires more calibration data, high hardware requirements and scene requirements, high algorithm complexity, and limited applicability.

Exemplarily, some new technologies may require more calibration data to obtain accurate extrinsic parameter estimation results. Some new technologies may require the use of specific hardware devices or sensors to assist in the calibration process, such as gyroscopes, accelerometers, etc. Some new technologies have certain requirements for calibration scenes, such as requiring sufficient feature points or a certain level of texture in the scene. On the other hand, some new fisheye lens extrinsic parameter calibration technologies use complex algorithm models or deep learning networks, which require higher computing resources and algorithm implementation complexity.

### BRIEF SUMMARY OF THE INVENTION

An embodiment of the present invention provides a method to fine-tune extrinsic parameters of a fisheye lens applied to surround-view stitching. The method includes the following steps. Fisheye images are obtained from multiple fisheye lenses. Both sides of the fisheye images contain calibration boards. Initial extrinsic parameters are obtained based on the fisheye images. Multiple corner points of the calibration boards in the fisheye images are detected. The corner points are sorted in sequence to form a quadrilateral. The initial extrinsic parameters are multiplied by a fine-tuning value to obtain intermediate extrinsic parameters. The corner points are projected onto the top-view projection by using the intermediate extrinsic parameters. The intermediate extrinsic parameters are adjusted according to the shape, size, and overlapping effect of the area surrounded by the corner points in the top-view projection.

An embodiment of the present invention also provides a system to fine-tune extrinsic parameters of a fisheye lens applied to surround-view stitching. The system includes multiple fisheye lenses and a processor. The fisheye lenses obtain fisheye images respectively. Both sides of the fisheye images contain calibration boards. The processor electrically couples to the fisheye lenses to obtain the fisheye images therefrom, obtains initial extrinsic parameters based on the fisheye images, and detect multiple corner points of the calibration boards in the fisheye images. The processor arranges the corner points so that the corner points are connected into a quadrilateral in sequence. The processor multiplies the initial extrinsic parameters by a fine-tuning value to obtain intermediate extrinsic parameters. The processor projects the corner points to a top-view projection by using the intermediate extrinsic parameters. The processor adjusts the intermediate extrinsic parameters according to the shape, size, and overlapping effect of the area surrounded by the corner points in the top-view projection.

The method and the system to fine-tune extrinsic parameters of a fisheye lens applied to surround-view stitching of the present disclosure fine-tunes the initial extrinsic parameters in sequence based on the calibration of the initial extrinsic parameters to make the surround-view stitching effect much better. Moreover, during the fine-tuning process of non-initial extrinsic parameter calibration, there is no need to place the calibration board with strictly accurately at every step, nor is it necessary to measure the distance between the two calibration boards. The method and the system to fine-tune extrinsic parameters of the fisheye lens applied to surround-view stitching of the present disclosure can improve the simplicity of operation, eliminate the need for high computing resources, and reduce the time-consuming fine-tuning process.

### BRIEF DESCRIPTION OF THE DRAWINGS

The present invention can be more fully understood by reading the subsequent detailed description and examples with references made to the accompanying drawings, wherein:

FIG. 1 shows a flow chart of a method to fine-tune extrinsic parameters of a fisheye lens applied to surround-view stitching in accordance with some embodiments of the present invention;

FIG. 2 shows a detail flow chart of step S112 in FIG. 1 in accordance with some embodiments of the present invention;

FIG. 3 shows a detail flow chart of step S200 in FIG. 2 in accordance with some embodiments of the present invention;

FIG. 4 shows a detail flow chart of step S202 in FIG. 2 in accordance with some embodiments of the present invention;

FIG. 5 shows a schematic diagram of executing steps S104 and S106 in FIG. 1 in accordance with some embodiments of the present invention;

FIGS. 6A and 6B show a comparison diagram of incorrectly executing step S106 in FIG. 1 in accordance with some embodiments of the present invention;

FIGS. 7A and 7B show a comparison diagram between before executing step S112 in FIG. 1 and after executing step S112 in FIG. 1 in a real scene with checkerboards neatly disposed in accordance with some embodiments of the present invention;

FIGS. 8A and 8B show a comparison diagram between before executing step S112 in FIG. 1 and after executing step S112 in FIG. 1 in a simulation platform with checkerboards randomly disposed in accordance with some embodiments of the present invention;

FIGS. 9A and 9B show a comparison diagram between before executing step S112 in FIG. 1 and after executing step S112 in FIG. 1 in a real scene with checkerboards randomly disposed in accordance with some embodiments of the present invention;

FIGS. 10A and 10B show a comparison diagram between before executing step S112 in FIG. 1 and after executing step S112 in FIG. 1 in a simulation platform with checkerboards randomly disposed in accordance with some embodiments of the present invention;

FIG. 11A is a schematic diagram of executing step S400 in FIG. 4 when one of the fisheye lenses is used as a reference of a roll angle and the roll angle is inaccurate in accordance with some embodiments of the present invention;

FIG. 11B is a schematic diagram of executing step S400 in FIG. 4 when one of the fisheye lenses is used as a reference of a roll angle and the roll angle is accurate in accordance with some embodiments of the present invention;

FIG. 12 is a schematic diagram of checkerboard spacings in accordance with some embodiments of the present invention;

FIG. 13 is a schematic diagram of a system 1300 to fine-tune extrinsic parameters of a fisheye lens applied to surround-view stitching in accordance with some embodiments of the present invention; and

FIG. 14 is a schematic diagram of an image with checkerboards captured by a single fisheye lens in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For instance, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

In order to better describe the embodiments of the present invention, the specific terms used in the present invention are firstly defined as below.

Fisheye lens: a fisheye lens is an ultra-wide-angle lens that produces strong visual distortion intended to create a wide panoramic or hemispherical image. A modern vehicle may install some cameras with fisheye lenses and then stitch images from these fisheye-lens cameras to show the real scene surrounding itself for driver's references.

Simulation platform: an online system used for simulating the surround-view effect of a vehicle. The simulated platform builds-in a lot of simulate vehicles, simulated fisheye lenses (embedded within cameras), simulated checkerboard calibration boards, and simulated locations as the provisions of users' online simulations. The users may select a simulated vehicle accompanied with cameras embedded with simulated lenses (mounted on the simulated vehicle) and simulated checkerboard calibration boards (surrounding the simulated vehicle) to simulate the surrounding effects of the simulated vehicle over the simulate platform. He/She may follow the simulation result he/she thought the best solution obtained from the simulation platform to physically allocate cameras with fisheye lenses (associated with the camera embedded with simulated fisheye lenses) on the vehicle (associated with the simulated vehicle).

Simulated vehicle: a vehicle in the simulated platform having intrinsic parameters (e.g., lengths, widths, heights, shapes, . . . , etc.) the same as that of associated real vehicle.

Simulated fisheye lens: a fisheye lens in the simulated platform having intrinsic parameters (e.g., focal length, optical center, and lens distortion . . . , etc.) the same as that of associated real fisheye lens.

Intermediate extrinsic parameter: an intermediate extrinsic parameter is the initial extrinsic parameter multiplied by a fine-tuned value. The intermediate extrinsic parameters are adjusted according to the shape, size, and overlapping effect of the area surrounded by the corner points in the top-view projection.

It should be noted that the technical features in different embodiments described in the following can be redisposed, recombined, or mixed with one another to constitute another embodiment without depart in from the spirit of the present invention.

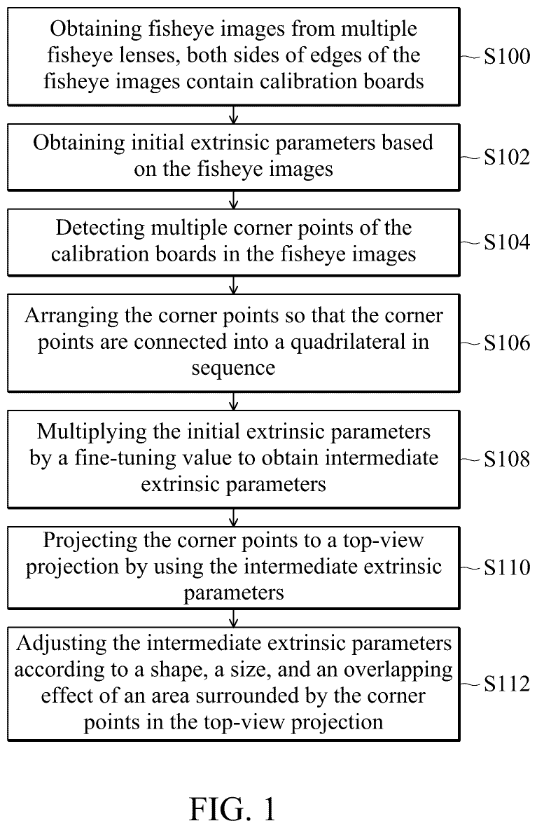

FIG. 1 shows a flow chart of a method to fine-tune extrinsic parameters of a fisheye lens applied to surround-view stitching in accordance with some embodiments of the present invention. As shown in FIG. 1, the method to fine-tune the extrinsic parameters of the fisheye lens includes the following steps. Fisheye images are obtained from multiple fisheye lenses. Both sides of the fisheye images contain calibration boards (step S100). Initial extrinsic parameters are obtained based on the fisheye images (step S102). Multiple corner points of the calibration boards in the fisheye images are detected (step S104). The corner points are arranged so that the corner points are connected into a quadrilateral in sequence (step S106). The initial extrinsic parameters are multiplied by a fine-tuning value to obtain intermediate extrinsic parameters (step S108). The corner points are projected to a top-view projection by using the intermediate extrinsic parameters (step S110). The intermediate extrinsic parameters are adjusted according to the shape, size, and overlapping effect of the area surrounded by the corner points in the top-view projection (step S112).

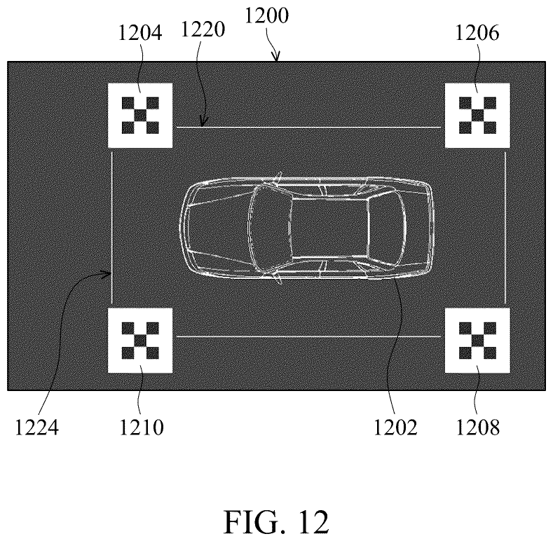

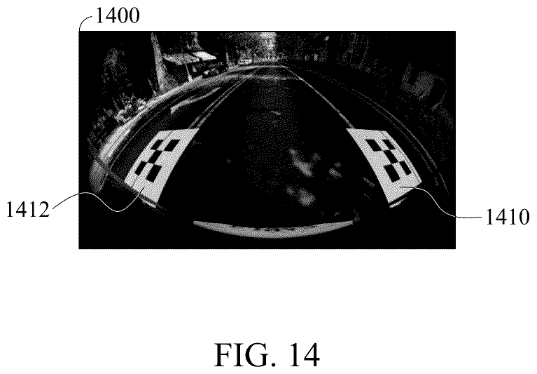

In step S100, the fisheye lenses are disposed on a real vehicle. In some embodiments, the number of the fisheye lenses disposed on the real vehicle may be, for instance, 4 or 6, but the present invention is not limited thereto. In step S100, the calibration boards are disposed around the real vehicle. In some embodiments, the calibration board may be, for instance, a checkerboard. The following uses the checkerboard as an example to illustrate. Generally speaking, the number of checkerboards is equal to the number of fisheye lenses, so that the fisheye images captured by two adjacent fisheye lenses can display the same checkerboard. For instance, if the 4 fisheye lenses are respectively disposed in front, rear, right and left of the real vehicle, then the 4 checkerboards are disposed in the front left, front right, rear left and rear right of the real vehicle (the specific location of the checkerboards may be shown in FIG. 12). Taking FIG. 12 as an example, the fisheye lens in front of the vehicle and the fisheye lens on the right side of the vehicle will capture the same checkerboard 1204. In some embodiments, taking FIG. 14 as an example, in the fisheye image 1400 captured by a single fisheye lens, as shown in FIG. 14, both sides of the fisheye image contain a checkerboard 1410 and a checkerboard 1412. Therefore, the fisheye image obtained from each fisheye lens includes a checkerboard on both sides. That is, the fisheye image obtained from each fisheye lens may include 2 checkerboards located on different sides.

In some embodiments, the method to fine-tune the extrinsic parameters of the fisheye lens of the present invention may also establish a simulated fisheye lens corresponding to the fisheye lens in a simulation platform based on internal parameters of the fisheye lens, instead of disposing the real fisheye lens on the real vehicle as in the above embodiment. The simulated fisheye lens is installed on a simulated vehicle in the simulation platform. The simulation platform may be, for instance, Carla, PerScan, CarSim, VIRES VTD, PTV Vissim and TESS NG, but the present invention is not limited thereto. The simulated vehicle is set up based on basic parameters of the real vehicle. Furthermore, objects such as calibration boards are created in the simulation platform so that objects such as calibration boards can be disposed around the simulated vehicle to simulate the settings of real fisheye lenses for extrinsic parameter fine-tuning of the real vehicle. In some embodiments, the calibration board may be a checkerboard.

In step S102, the method to fine-tune the extrinsic parameters of the fisheye lens of the present invention executes an extrinsic parameter calibration process to obtain initial extrinsic parameters based on the fisheye images in step S100. In detail, the method to fine-tune the extrinsic parameters of the fisheye lens of the present invention executes a checkerboard corner-point detection algorithm to calculate a coordinate position (img_pt) of a corner point of the checkerboard in the fisheye image. In addition, in step S102, the step of obtaining the initial extrinsic parameters of the fisheye lenses of the present invention requires reference to a distance between two adjacent checkerboards in FIG. 12. The detailed description is as follows. As shown in FIG. 12, a top-view projection 1200 includes a vehicle 1202, checkerboards 1204, 1206, 1208, and 1210, which are disposed around the vehicle 1202 (for instance: right front, right rear, left rear and right front). The distance between the checkerboards 1204 and 1206 is 1220, and the distance between the checkerboards 1208 and 1210 is also 1220. The distance between the checkerboards 1204 and 1210 is 1224, and the distance between the checkerboards 1206 and 1208 is also 1224. It is worth noting that in the method of obtaining the initial extrinsic parameters, it is better to dispose the checkerboards around the vehicle 1202 neatly as shown in FIG. 12. It should be noted here that the neat placement of the checkerboard means that during the placement process, both sides of the checkerboard must be parallel to the vehicle body, or the other two sides of the checkerboard must be perpendicular to the vehicle body. If the above placement requirements are not met, it will be considered as an improper placement. Afterwards, the method to fine-tune the extrinsic parameters of the fisheye lens of the present invention calculates a coordinate position (obj_pt) of the corner point of the checkerboard in a world coordinate system based on the distance between two adjacent checkerboards, the arrangement of the checkerboards around the vehicle, and the number of checkerboards. Finally, the method to fine-tune the extrinsic parameters of the fisheye lens of the present invention calculates the initial extrinsic parameters of each fisheye lens based on the coordinate position (img_pt) in the fisheye image and the coordinate position (obj_pt) in the world coordinate system. In some embodiments, the initial extrinsic parameters may be presented, for instance, in a matrix.

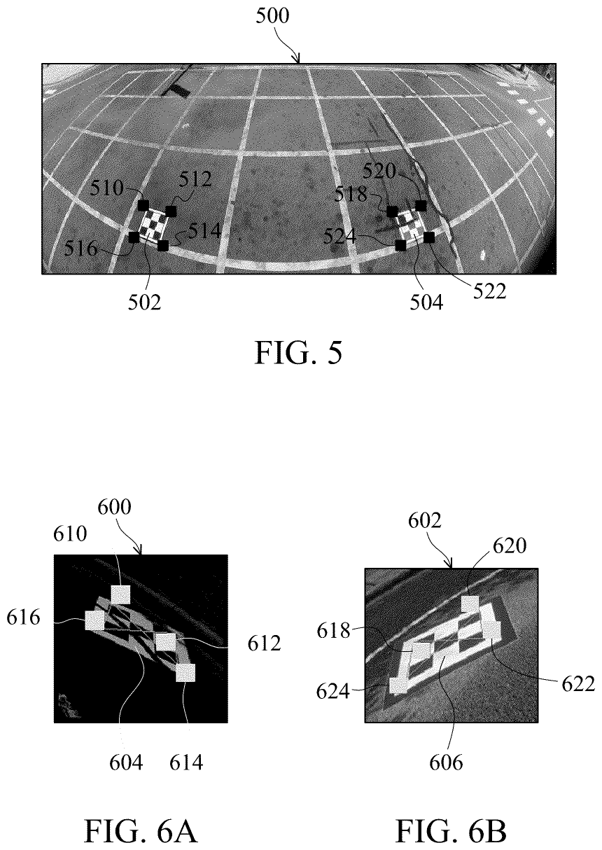

After that, in step S104, the method to fine-tune the extrinsic parameters of the fisheye lens of the present invention detects the corner points of the checkerboards in the fisheye images based on the checkerboard corner-point detection algorithm. In step S106, the method to fine-tune the extrinsic parameters of the fisheye lens of the present invention arranges the corner points so that the corner points are connected into a quadrilateral in sequence based on the checkerboard corner-point detection algorithm. Taking FIG. 5 as an example to illustrate steps S104 and 106. The method to fine-tune the extrinsic parameters of the fisheye lens of the present invention detects the corner points of the checkerboard 502 and the checkerboard 504 in fisheye image 500, and connects the four corner points of the checkerboards based on the checkerboard corner-point detection algorithm, so that the four corner points can be connected into a quadrilateral in sequence. Furthermore, it is detected that the checkerboard 502 includes corner points 510, 512, 514 and 516, and it is detected that the checkerboard 504 includes corner points 520, 522, 518 and 524. Next, the corner points of the checkerboard 502 are connected in sequence, and in the present invention, the connection direction of the corner points is not limited, that is, it can be clockwise or counterclockwise. As long as these corner points are connected sequentially to form a quadrilateral, this quadrilateral is treated as the outer contour of the checkerboard. In addition, the outer corner points of the checkerboard 504 are sequentially connected so that these corner points can be sequentially connected into a quadrilateral, which is the outer contour of the checkerboard, and may be used to confirm the correct range of the checkerboard in the fisheye image, but the present invention is not limited thereto.

Taking FIGS. 6A and 6B as examples, based on the checkerboard corner-point detection algorithm, the method to fine-tune the extrinsic parameters of the fisheye lens of the present invention detects the corner points of the checkerboards 604 and 606 in the fisheye images 600 and 602, respectively, and connects the four corner points in the checkerboard. Furthermore, it is detected that the checkerboard 604 includes corner points 610, 612, 614, and 616. It is detected that the checkerboard 606 includes corner points 618, 620, 622, and 624. If an error occurs during the execution of step S106 (for instance, the diagonal connection between corner points 610 and 614), these corner points fail to form a quadrilateral, when sequentially connected, failing to present the contour of the checkerboard. That is, these corner points should be no cross-connected between each other. The purpose of step S106 is to confirm a range of the checkerboard in the fisheye image. If the corner points are connected incorrectly, that is, these corner points fail to form a quadrilateral, it is impossible to confirm the correct range of the checkerboard in the fisheye image.

Then, in step S108, the method to fine-tune the extrinsic parameters of the fisheye lens of the present invention multiplies the initial extrinsic parameters by a fine-tuning value based on an extrinsic-parameter fine-tuning algorithm. Specifically, the fine-tuning value is an assumed value derived based on the pitch angle, yaw angle, and zoom value (z) to obtain intermediate extrinsic parameters. It is stated that the intermediate extrinsic parameters refer to relative intermediate values between the initial extrinsic parameters and the final extrinsic parameters during the extrinsic parameter fine-tuning process.

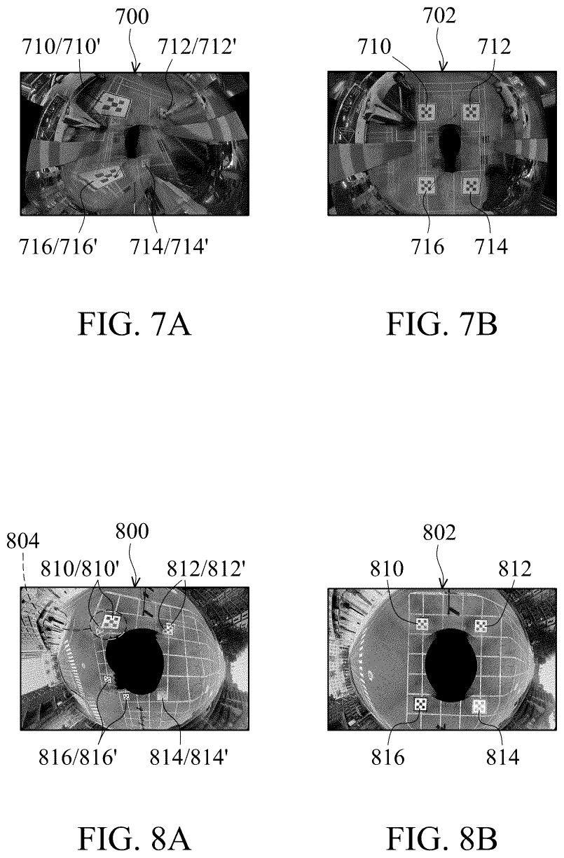

Afterwards, in step S110, the method to fine-tune the extrinsic parameters of the fisheye lens of the present invention projects the corner points to a top-view projection by using the intermediate extrinsic parameters based on a surround-view stitching algorithm. The projected top-view diagram may be shown in FIGS. 7A, 8A, 9A, and 10A. Each fisheye image captured by a fisheye lens contains two checkerboards, and the two checkerboards in the fisheye image are shown on both sides of the fisheye image. Therefore, the number of checkerboards in the top-view diagram obtained by projecting the corner points using the intermediate extrinsic parameters is twice the number of disposed checkerboards. FIGS. 7A, 8A, 9A, and 10A will be described later.

After that, in step S112, the method to fine-tune the extrinsic parameters of the fisheye lens of the present invention adjusts the intermediate extrinsic parameters according to the shape, size, and overlapping effect of the area surrounded by the corner points in the top-view projection based on the extrinsic-parameter fine-tuning algorithm.

In some embodiments, after finishing step S112, the method to fine-tune the extrinsic parameters of the fisheye lens of the present invention projects the fisheye images obtained from the fisheye lenses respectively to the top-view projection by using adjusted intermediate extrinsic parameters. In some embodiments, the top-view projection may be, for instance, a surround-view stitching image, but the present invention is not limited thereto.

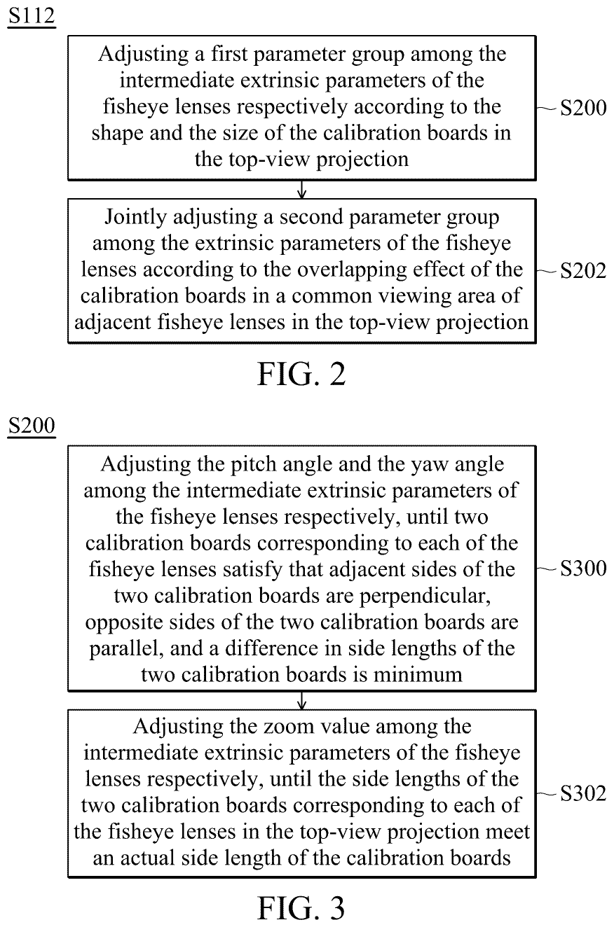

FIG. 2 shows a detail flow chart of step S112 in FIG. 1 in accordance with some embodiments of the present invention. As shown in FIG. 2, in step S112 of FIG. 1, the method to fine-tune the extrinsic parameters of the fisheye lens of the present invention includes the following steps. A first parameter group among the intermediate extrinsic parameters of the fisheye lenses is adjusted respectively according to the shape and the size of the calibration boards in the top-view projection (step S200). A second parameter group among the extrinsic parameters of the fisheye lenses is jointly adjusted according to the overlapping effect of the calibration boards in a overlapping region (for instance, a common viewing area 804 in FIG. 8A) of adjacent fisheye lenses in the top-view projection (step S202). In step S200, the first parameter group includes a pitch angle, a yaw angle, and a zoom value (z). In step S202, the second parameter group includes a roll angle, a horizontal offset value (x), and a vertical offset value (y). Specifically, the horizontal offset value (x) is a horizontal fine-tuning value along an x-axis in the top-view projection (i.e., the surround-view stitching image). The vertical offset value (y) is a vertical fine-tuning value along a y-axis in the top-view projection. The zoom value (z) is a scaling value along a z-axis in the top-view projection, where the z-axis is orthogonal to the top-view projection (i.e., the same direction as the normal line of the top-view projection or opposite to it).

The pitch angle is a rotation fine-tuning value around the x-axis in the top-view projection. The yaw angle is a rotation fine-tuning value around the y-axis in the top-view projection. The roll angle is a rotation fine-tuning value around the z-axis in the top-view projection.

FIG. 3 shows a detail flow chart of step S200 in FIG. 2 in accordance with some embodiments of the present invention. As shown in FIG. 3, in step S200 of FIG. 2, the method to fine-tune the extrinsic parameters of the fisheye lens of the present invention includes the following steps. The pitch angle and the yaw angle among the intermediate extrinsic parameters of the fisheye lenses are adjusted respectively, until two calibration boards corresponding to each of the fisheye lenses satisfy the requirements of having perpendicular adjacent sides, parallel opposite sides, and the minimum difference in edge lengths (step S300). The zoom value (z) among the intermediate extrinsic parameters of the fisheye lenses is adjusted respectively, until the side lengths of the two calibration boards corresponding to each of the fisheye lenses in the top-view projection meet an actual side length of the calibration boards (step S302). In some embodiments, in steps S300 and S302, the method to fine-tune the extrinsic parameters of the fisheye lens of the present invention may adjust the pitch angle, the yaw angle, and the zoom value (z) of each fisheye lens at the same time, or may adjust the pitch angle, the yaw angle, and the zoom value (z) of each fisheye lens in sequence.

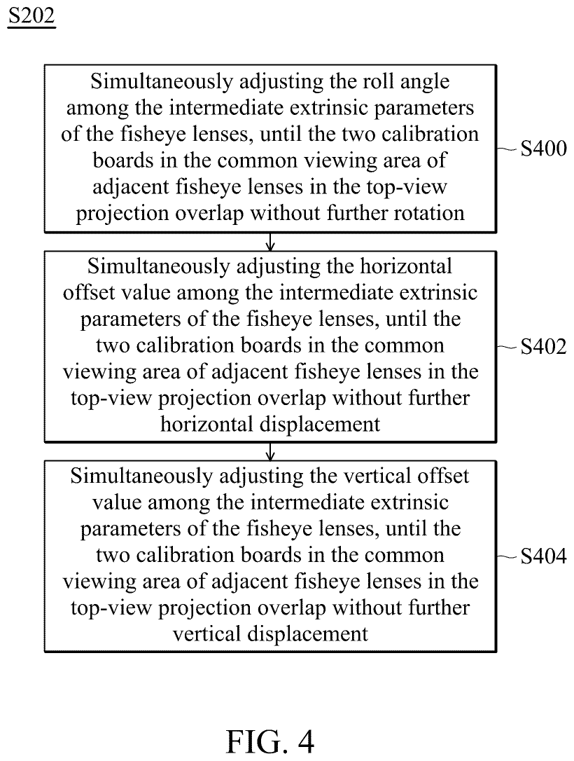

FIG. 4 shows a detail flow chart of step S202 in FIG. 2 in accordance with some embodiments of the present invention. As shown in FIG. 4, in step S202 of FIG. 2, the method to fine-tune the extrinsic parameters of the fisheye lens of the present invention includes the following steps. The roll angle among the intermediate extrinsic parameters of the fisheye lenses is simultaneously adjusted, until the two calibration boards in the overlapping area of adjacent fisheye lenses in the top-view projection without requiring any further rotation (step S400). The two checkerboards in this common viewing area will completely overlap, and visually there is only one checkerboard. The horizontal offset value (x) among the intermediate extrinsic parameters of the fisheye lenses is simultaneously adjusted, until the two calibration boards in the overlapping area of adjacent fisheye lenses in the top-view projection overlap without requiring any further horizontal displacement (step S402). The two checkerboards in this common viewing area will completely overlap, and visually there is only one checkerboard. The vertical offset value (y) among the intermediate extrinsic parameters of the fisheye lenses, until the two calibration boards in the overlapping area of adjacent fisheye lenses in the top-view projection overlap without requiring any further vertical displacement (step S404). The two checkerboards in this common viewing area will completely overlap, and visually there is only one checkerboard.

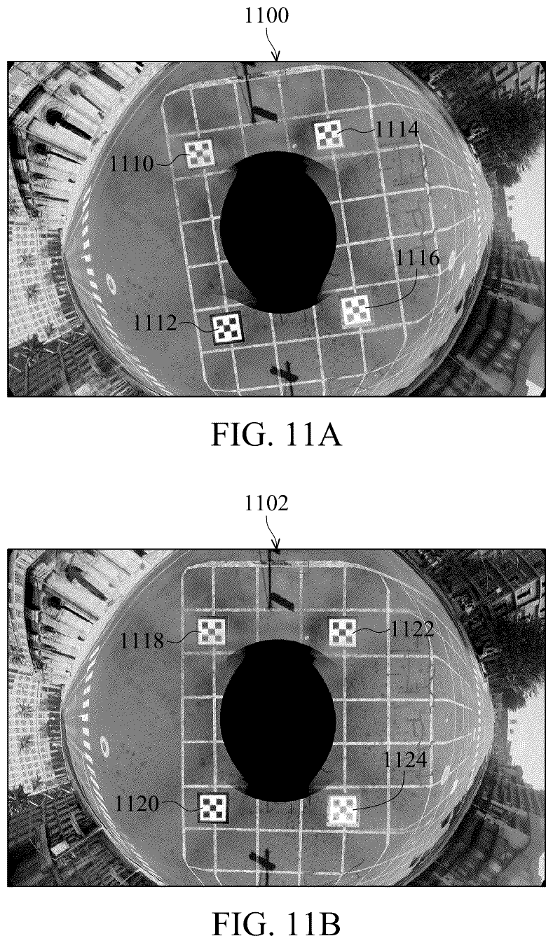

In some embodiments where the real vehicle has four fisheye lenses (including a front lens, a rear lens, a left lens, and a right lens), or the simulated vehicle has four simulated fisheye lenses, the method to fine-tune the extrinsic parameters of the fisheye lens of the present invention pre-assumes in step S400 that the roll angle of the front lens is correct, firstly. Then, based on the roll angle of the front lens, the method to fine-tune the extrinsic parameters of the fisheye lens of the present invention simultaneously adjusts the roll angles of the rear lens, the left lens, and the right lens, until the two calibration boards in the common viewing area of adjacent fisheye lenses in the top-view projection overlap without further rotation. That is, the two checkerboards in the common viewing area will completely overlap, and visually there is only one checkerboard. In some embodiments, if the roll angle of the front lens is correct, that is, the installation of the front camera on the actual vehicle is aligned with the orientation of the vehicle; in other words, the front camera on the actual vehicle is not tilted relative to the vehicle's direction., then a top-view projection is obtained upon completion of steps S100 to S200. In contrast, if the roll angle of the front lens is incorrect (i.e., the roll angle of the front lens has a deviation), the installation of the front camera on the actual vehicle is tilted, after steps S400 to S404 in FIG. 4 are completed, a top-view projection 1100 of FIG. 11A can be obtained. When the roll angle of the front lens is incorrect, although it does not affect the panoramic stitching effect, the entire panoramic image will be shifted by an angle, which impacts the driver's judgment of the surrounding scene's position relative to the vehicle. Therefore, when the roll angle of the front lens is incorrect, the method to fine-tune the extrinsic parameters of the fisheye lens of the present invention may compensate for the deviation of the roll angle in the front lens to obtain the top-view projection 1102 of FIG. 11B.

In step S400, the method to fine-tune the extrinsic parameters of the fisheye lens of the present invention first calculates the roll angle error of two calibration boards in the common viewing area of adjacent fisheye lenses in the top-view projection. Then, the method to fine-tune the extrinsic parameters of the fisheye lens of the present invention sums the roll angle error of adjacent fisheye lenses to obtain a global roll angle error. Finally, the method to fine-tune the extrinsic parameters of the fisheye lens of the present invention obtains the fine-tuning value of the roll angle of the fisheye lenses to minimize the global roll angle error.

In step S402, the method to fine-tune the extrinsic parameters of the fisheye lens of the present invention first calculates a horizontal offset error of the two calibration boards in the common viewing area of adjacent fisheye lenses in the top-view projection. Then, the method to fine-tune the extrinsic parameters of the fisheye lens of the present invention sums the horizontal offset error of adjacent fisheye lenses to obtain a global horizontal offset error. Finally, by using the method to fine-tune the extrinsic parameters of the fisheye lens of the present invention obtains the fine-tuning value of the horizontal offset value of the fisheye lenses to minimize the global horizontal offset error.

In step S404, the method to fine-tune the extrinsic parameters of the fisheye lens of the present invention first calculates a vertical offset error of the two calibration boards in the common viewing area of adjacent fisheye lenses in the top-view projection. Then, the method to fine-tune the extrinsic parameters of the fisheye lens of the present invention sums the vertical offset error of adjacent fisheye lenses to obtain a global vertical offset error. Finally, the method to fine-tune the extrinsic parameters of the fisheye lens of the present invention obtains the fine-tuning value of the vertical offset value of the fisheye lenses to minimize the global vertical offset error.

FIGS. 7A and 7B show a comparison diagram between before executing step S112 in FIG. 1 and after executing step S112 in FIG. 1 in a real scene with checkerboards neatly disposed in accordance with some embodiments of the present invention. FIGS. 700 and 702 are top-view diagrams before and after executing step S112, respectively. As shown in FIG. 7A, the top-view projection 700 includes checkerboards 710/710′, 712/712′, 714/714′, and 716/716′. Since the extrinsic parameter adjustment step of step S112 of FIG. 1 has not been executed, the number of checkerboards obtained in the top-view projection is twice the number of checkerboards established in the simulation platform, and the shapes and sizes of the checkerboards projected into the top-view projection using the intermediate extrinsic parameters are inconsistent and do not conform to the actual side length of the checkerboard. In other words, the checkerboards in the common viewing area do not overlap.

As shown in FIG. 7B, the top-view projection includes a checkerboard 710, a checkerboard 712, a checkerboard 714, and a checkerboard 716. Since step S112 of FIG. 1 has been executed, after fine-tuning the extrinsic parameters, the shape and size of the checkerboard in the top-view projection are identical and conform to the actual side length of the checkerboard As shown in the top-view projection of FIG. 7A, the checkerboards 710/710′,712/712′, 714/714′, and 716/716′completely overlap to form the checkerboards 710, 712, 714, and 716, respectively. In other words, the checkerboards in the common viewing area completely overlap. In some embodiments, since the checkerboards in FIG. 7A and FIG. 7B are neatly disposed, this checkboard configuration may be applied not only to steps S104 to S112 in FIG. 1, but also to step S102 in FIG. 1 to obtain the initial extrinsic parameters of the fisheye lenses.

FIGS. 8A and 8B show a comparison diagram between before executing step S112 in FIG. 1 and after executing step S112 in FIG. 1 in a simulation platform with checkerboards neatly disposed in accordance with some embodiments of the present invention. In some embodiments, the simulation platform may be, for instance, Carla, PerScan, CarSim, VIRES VTD, PTV Vissim and TESS NG, but the present invention is not limited thereto. FIG. 800 is the top-view diagrams before and after executing step S112, respectively. As shown in FIG. 8A, the top-view projection 800 includes checkerboards 810/810′, 812/812′, 814/814′, and 816/816′. Since the extrinsic parameter adjustment step of step S112 of FIG. 1 has not been executed, the number of checkerboards obtained in the top-view projection is twice the number of checkerboards established in the simulation platform, and the shapes and sizes of the checkerboards projected into the top-view projection using the intermediate extrinsic parameters are inconsistent and do not conform to the real side length of the checkerboard. In other words, the checkerboards in a common viewing area 804 do not overlap. As shown in FIG. 8B, a top-view projection 802 includes a checkerboard 810, a checkerboard 812, a checkerboard 814, and a checkerboard 816. Since step S112 of FIG. 1 has been executed, the shape and size of the checkerboard in the top-view projected with the fine-tuned extrinsic parameters are the same and conform to the real side length of the checkerboard. As shown in the top-view projection of FIG. 8A, the checkerboards 810/810′ 812/812′, 814/814′, and 816/816′completely overlap to form the checkerboard 810, 812, 814, and 816, respectively. In other words, the checkerboards in the common viewing area 804 completely overlap. In some embodiments, since the checkerboards in FIG. 8A and FIG. 8B are neatly disposed, the setting scene can be applied not only to steps S104 to S112 in FIG. 1, but also to step S102 in FIG. 1 to obtain the initial extrinsic parameters of the fisheye lenses.

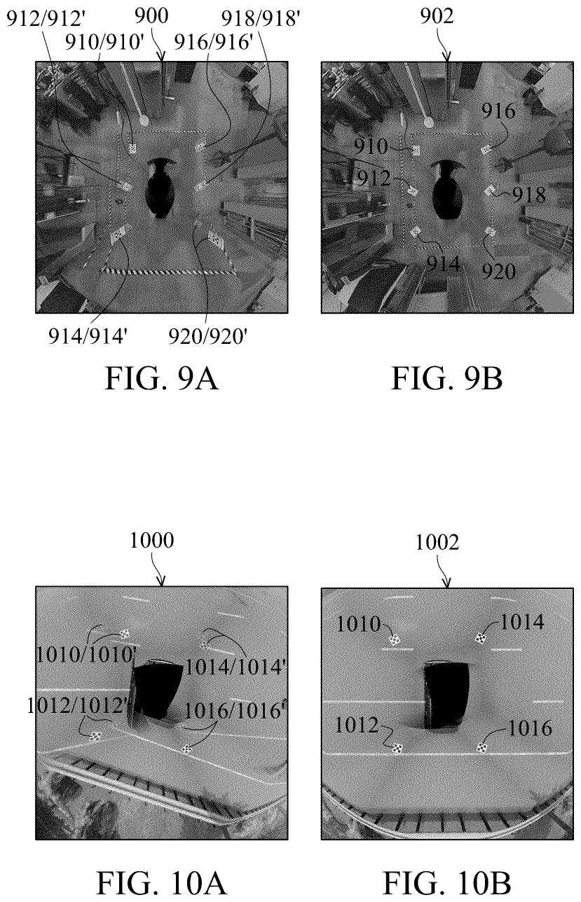

FIGS. 9A and 9B show a comparison diagram between before executing step S112 in FIG. 1 and after executing step S112 in FIG. 1 in a real scene with checkerboards randomly disposed in accordance with some embodiments of the present invention. A top-view projection 900 is the top-view projection before executing step S112 in FIG. 1. A top-view projection 902 is the top-view projection after executing step S112 in FIG. 1. As shown in FIG. 9A, the top-view projection 900 includes checkerboards 910/910′, 912/912′, 914/914′, 916/916′, 918/918′, and 920/920′. Since the extrinsic parameter adjustment step of step S112 of FIG. 1 has not been executed, the number of checkerboards obtained in the top-view projection is twice the number of checkerboards established in the simulation platform, and the shapes and sizes of the checkerboards projected into the top-view projection using the intermediate extrinsic parameters are inconsistent and do not conform to the real side length of the checkerboard. In other words, the checkerboards in the common viewing area do not overlap.

As shown in FIG. 9B, the top-view projection 902 includes a checkerboard 910, a checkerboard 912, a checkerboard 914, a checkerboard 916, a checkerboard 918, and a checkerboard 920. Since step S112 of FIG. 1 has been executed, the shape and size of the checkerboard in the top-view projected with the fine-tuned extrinsic parameters are the same and conform to the real side length of the checkerboard. As shown in the top-view projection of FIG. 9A, the checkerboards 910/910′, 912/912′, 914/914′, 916/916′, 918/918′, and 920/920′ completely overlap to form the checkerboard 910,912,914,916,918, and 920, respectively. In other words, the checkerboards in the common viewing area completely overlap. In some embodiments, since the checkerboards in FIG. 9A and FIG. 9B are randomly disposed, the setting scene cannot be applied to the initial extrinsic parameter fine-tuning of step S102 in FIG. 1, but can be applied to steps S104 to S112 in FIG. 1.

FIGS. 10A and 10B show a comparison diagram between before executing step S112 in FIG. 1 and after executing step S112 in FIG. 1 in a simulation platform with checkerboards randomly disposed in accordance with some embodiments of the present invention. In some embodiments, the simulation platform may be, for instance, Carla, PerScan, CarSim, VIRES VTD, PTV Vissim and TESS NG, but the present invention is not limited thereto. A top-view projection 1000 is the top-view projection before executing step S112 in FIG. 1. A top-view projection 1002 is the top-view projection after executing step S112 in FIG. 1. As shown in FIG. 10A, the top-view projection 1000 includes checkerboards 1010/1010′, 1012/1012′, 1014/1014′, and 1016/1016′. Since the extrinsic parameter adjustment step of step S112 of FIG. 1 has not been executed, the number of checkerboards obtained in the top-view projection is twice the number of checkerboards established in the simulation platform, and the shapes and sizes of the checkerboards projected into the top-view projection using the intermediate extrinsic parameters are inconsistent and do not conform to the real side length of the checkerboard. In other words, the checkerboards in the common viewing area do not overlap.

As shown in FIG. 10B, the top-view projection 1002 includes a checkerboard 1010, a checkerboard 1012, a checkerboard 1014, and a checkerboard 1016. Since step S112 of FIG. 1 has been executed, the shape and size of the checkerboard in the top-view projected with the fine-tuned extrinsic parameters are the same and conform to the real side length of the checkerboard. As shown in the top-view projection of FIG. 10A, the checkerboards 1010/1010′, 1012/1012′, 1014/1014′ and 1016/1016′ completely overlap to form the checkerboard 1010, 1012,1014, and 1016, respectively. In other words, the checkerboards in the common viewing area completely overlap. In some embodiments, since the checkerboards in FIG. 10A and FIG. 10B are randomly disposed, the setting scene cannot be applied to step S102 in FIG. 1, but can be applied to steps S104 to S112 in FIG. 1.

As can be seen from the above FIGS. 7 to 10, in step 104 to step S112, when fine-tuning the extrinsic parameters, the checkerboards can be disposed randomly as shown in FIGS. 9A, 9B, 10A and 10B. Furthermore, during the placement of the checkerboards, it is not necessary to ensure that the two sides of the checkerboard are parallel to the vehicle body, nor that the other two sides are perpendicular to it, nor to measure the distance between adjacent checkerboards as shown in FIG. 12. The extrinsic parameter fine-tuning can still be performed. In some embodiments, the checkerboards can also be disposed neatly as shown in FIGS. 7A, 7B, 8A and 8B, that is, during the placement process of the checkerboard, the two sides of the checkerboard are parallel to the vehicle body, and the other two sides are perpendicular to the vehicle body. Additionally, the distance between adjacent checkerboards, as shown in FIG. 12 are obtained to successfully apply the process from Step S102 to Step S112.

In some embodiments, the present invention may be used to calibrate multiple vehicles of the same model. Conventionally, initial extrinsic parameter calibration must be performed on each vehicle of the same model individually, which significantly reduces Since the models are the same, the initial extrinsic parameters of one vehicle are also applicable to multiple other vehicles of the same model. Therefore, any one vehicle can be selected for initial extrinsic parameter calibration, and then the extrinsic parameter fine-tuning method of the present invention can be used to fine-tune the initial extrinsic parameters of multiple other vehicles to obtain extrinsic parameters. Since the checkerboard can be disposed randomly as shown in FIG. 9A, FIG. 9B, FIG. 10A and FIG. 10B when the extrinsic parameter is fine-tuned by using the present invention, and there is no need to obtain the distance between two adjacent checkerboard grids as shown in FIG. 12, the initial extrinsic parameter calibration efficiency can be further improved.

It should be noted that in the present invention, when fine-tuning the extrinsic parameters in steps S104 to S112 in a real scene, it is unnecessary to arrange the checkerboard precisely. Compared with the currently known extrinsic parameter fine-tuning methods, it still requires the chessboards to be arranged neatly in real-world scenarios. Since the placements of the chessboards are done manually and subject to space limitations, it is often difficult to achieve precise placement, resulting in an inadequate overhead view projection (for instance, the surround-view stitching image). Therefore, the method of the present invention is relatively simple to perform.

FIG. 11A is a schematic diagram of executing step S400 in FIG. 4 when one of the fisheye lenses is used as a reference of a roll angle and the roll angle is inaccurate in accordance with some embodiments of the present invention. As shown in FIG. 11A, a top-view projection 1100 includes checkerboards 1110, 1112, 1114, and 1116. In some embodiments of FIG. 11A, a front lens is disposed between the checkerboard 1110 and the checkerboard 1114. When the front lens is used as a reference of the roll angle and its roll angle is inaccurate, step S400 of FIG. 4 is executed to obtain the top-view projection 1100. Since the roll angle of the front lens is incorrect (i.e., there is a deviation in the roll angle of the front lens), the front lens on the vehicle is skewed, resulting in a deviation in the roll angle of the top-view projection as well.

FIG. 11B is a schematic diagram of executing step S400 in FIG. 4 where one of these fisheye cameras is used as the roll angle reference and its roll angle is accurate in accordance with some embodiments of the present invention. As shown in FIG. 11B, a top-view projection 1102 includes checkerboards 1118, 1120, 1122, and 1124. In some embodiments of FIG. 11B, a front lens is disposed between the checkerboard 1118 and the checkerboard 1122. When the front lens is used as a reference of the roll angle and its roll angle is accurate, step S400 of FIG. 4 is executed to obtain the top-view projection 1102. Since the roll angle of the front lens camera is correct, meaning this camera is correctly oriented on the actual vehicle, the top-down view 1102 is properly aligned. In some embodiments, in the case where the roll angle of the front camera is incorrect, although it does not affect the panoramic stitching effect, the entire panoramic image will be tilted by an angle, which affects the driver's judgment of the scenes surrounding the vehicle. The method to fine-tune the extrinsic parameters of the fisheye lens of the present invention compensates for the deviation of the roll angle of the front lens to modify the top-view projection 1100 of FIG. 11A into the top-view projection 1102 of FIG. 11B.

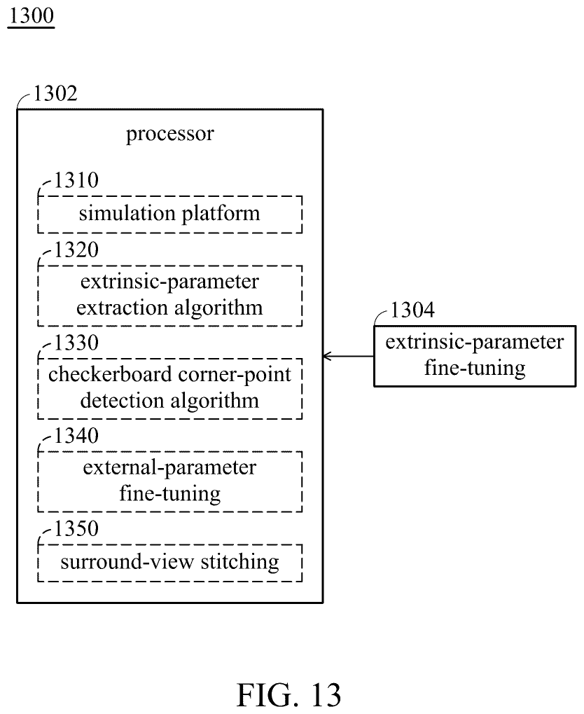

FIG. 13 is a schematic diagram of a system 1300 to fine-tune extrinsic parameters of a fisheye lens applied to surround-view stitching in accordance with some embodiments of the present invention. As shown in FIG. 13, the system 1300 to fine-tune extrinsic parameters of the fisheye lens includes a processor 1302 and multiple fisheye lenses 1304. In some embodiments, the fisheye lenses 1304 are disposed on a real vehicle, and the number of the fisheye lenses 1304 may be, for instance, 4 or 6, but the present invention is not limited thereto. A plurality of checkerboards are disposed around the real vehicle, and the relevant contents have been described in step S100 and will not be repeated here.

In some embodiments, the processor 1302 is configured to execute steps S100 to S112 in FIG. 1, steps S200 and S202 in FIG. 2, steps S300 and S203 in FIG. 3, and steps S400 to S404 in FIG. 4. In detail, the processor 1302 executes an extrinsic-parameter extraction algorithm 1320 to complete step S102 in FIG. 1, and selects appropriate initial extrinsic parameters. The processor 1302 executes a checkerboard corner-point detection algorithm 1330 to complete steps S104 and S106 in FIG. 1. The corner-point detection algorithm may be corner-point detection based on binary images, corner-point detection based on contour curves, or corner-point detection based on grayscale images, etc. The processor 1302 executes an extrinsic-parameter fine-tuning 1340 to complete steps S108 and S112 in FIG. 1. The processor 1302 executes a surround-view stitching 1350 to complete step S110 in FIG. 1. The 1302 executes the surround-view stitching 1350 to project the fisheye images obtained from the fisheye lenses 1304 respectively into the top-view projection using the intermediate extrinsic parameters adjusted in step S112.

Aiming at the limitations and shortcomings of the fisheye lens extrinsic parameter calibration technology, the present invention comprehensively considers the specific application requirements, scene conditions and feasibility, and proposes an extrinsic parameter sequential fine-tuning correction algorithm, which sequentially fine-tunes the initial extrinsic parameters on the basis of the initial extrinsic parameter calibration, thereby obtaining an extrinsic parameter calibration result with better surround stitching effect. In addition, the method to fine-tune the extrinsic parameters of the fisheye lens of the present invention does not require strict and accurate placement of checkerboards and distance measurement, which improves the convenience of usage. In addition, the fine-tuning process is short in time and does not require high computing resources.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method to fine-tune extrinsic parameters of a fisheye lens applied to surround-view stitching, comprising:
obtaining fisheye images from multiple fisheye lenses; wherein both sides of the fisheye images contain calibration boards;
obtaining initial extrinsic parameters based on the fisheye images;
detecting multiple corner points of the calibration boards in the fisheye images;
arranging the corner points so that the corner points are connected into a quadrilateral in sequence;
multiplying the initial extrinsic parameters by a fine-tuning value to obtain intermediate extrinsic parameters;
projecting the corner points to a top-view projection by using the intermediate extrinsic parameters, and
adjusting the intermediate extrinsic parameters according to a shape, a size, and overlapping effect of an area surrounded by the corner points in the top-view projection.

2. The method to fine-tune the extrinsic parameters of the fisheye lens as claimed in claim 1, wherein the step of adjusting the intermediate extrinsic parameters according to the shape, the size, and the overlapping effect of the area surrounded by the corner points in the top-view projection, comprises:
adjusting a first parameter group among the intermediate extrinsic parameters of the fisheye lenses respectively according to the shape and the size of the calibration boards in the top-view projection; and
jointly adjusting a second parameter group among the extrinsic parameters of the fisheye lenses according to the overlapping effect of the calibration boards in a common viewing area of adjacent fisheye lenses in the top-view projection.

3. The method to fine-tune the extrinsic parameters of the fisheye lens as claimed in claim 2, wherein the first parameter group comprises a pitch angle, a yaw angle, and a zoom value.

4. The method to fine-tune the extrinsic parameters of the fisheye lens as claimed in claim 3, wherein the step of adjusting the first parameter group among the intermediate extrinsic parameters of the fisheye lenses respectively according to the shape and the size of the calibration boards in the top-view projection, comprises:
adjusting the pitch angle and the yaw angle among the intermediate extrinsic parameters of the fisheye lenses respectively, until two calibration boards corresponding to each of the fisheye lenses satisfy requirements that adjacent sides of the two calibration boards be perpendicular, that opposite sides of the two calibration boards be parallel, and that a difference in side lengths of the two calibration boards be minimal; and
adjusting the zoom value among the intermediate extrinsic parameters of the fisheye lenses respectively, until the side lengths of the two calibration boards corresponding to each of the fisheye lenses in the top-view projection meet an actual side length of the calibration boards.

5. The method to fine-tune the extrinsic parameters of the fisheye lens as claimed in claim 2, wherein the second parameter group comprises a roll angle, a horizontal offset value, and a vertical offset value.

6. The method to fine-tune the extrinsic parameters of the fisheye lens as claimed in claim 5, wherein the step of jointly adjusting the second parameter group among the extrinsic parameters of the fisheye lenses according to the overlapping effect of the calibration boards in the common viewing area of adjacent fisheye lenses in the top-view projection, comprises:
simultaneously adjusting the roll angle among the intermediate extrinsic parameters of the fisheye lenses, until the two calibration boards in the common viewing area of adjacent fisheye lenses in the top-view projection overlap without further rotation;
simultaneously adjusting the horizontal offset value among the intermediate extrinsic parameters of the fisheye lenses, until the two calibration boards in the common viewing area of adjacent fisheye lenses in the top-view projection overlap without further horizontal displacement; and
simultaneously adjusting the vertical offset value among the intermediate extrinsic parameters of the fisheye lenses, until the two calibration boards in the common viewing area of adjacent fisheye lenses in the top-view projection overlap without further vertical displacement.

7. The method to fine-tune the extrinsic parameters of the fisheye lens as claimed in claim 6, wherein the step of simultaneously adjusting the roll angle among the intermediate extrinsic parameters of the fisheye lenses until the two calibration boards in the common viewing area of adjacent fisheye lenses in the top-view projection overlap without further rotation, comprises:
calculating a roll angle error of the two calibration boards in the common viewing area of adjacent fisheye lenses in the top-view projection;
summing the roll angle error of adjacent fisheye lenses to obtain a global roll angle error; and
obtaining the fine-tuning value of the roll angle of the fisheye lenses to minimize the global roll angle error.

8. The method to fine-tune the extrinsic parameters of the fisheye lens as claimed in claim 6, wherein the step of simultaneously adjusting the horizontal offset value among the intermediate extrinsic parameters of the fisheye lenses until the two calibration boards in the common viewing area of adjacent fisheye lenses in the top-view projection overlap without further horizontal displacement, comprises:
calculating a horizontal offset error of the two calibration boards in the common viewing area of adjacent fisheye lenses in the top-view projection;
summing the horizontal offset error of adjacent fisheye lenses to obtain a global horizontal offset error; and
obtaining the fine-tuning value of the horizontal offset value of the fisheye lenses to minimize the global horizontal offset error.

9. The method to fine-tune the extrinsic parameters of the fisheye lens as claimed in claim 6, wherein the step of simultaneously adjusting the vertical offset value among the intermediate extrinsic parameters of the fisheye lenses until the two calibration boards in the common viewing area of adjacent fisheye lenses in the top-view projection overlap without further vertical displacement, comprises:
calculating a vertical offset error of the two calibration boards in the common viewing area of adjacent fisheye lenses in the top-view projection;
summing the vertical offset error of adjacent fisheye lenses to obtain a global vertical offset error; and
obtaining the fine-tuning value of the vertical offset value of the fisheye lenses to minimize the global vertical offset error.

10. The method to fine-tune the extrinsic parameters of the fisheye lens as claimed in claim 1, further comprising:
projecting the fisheye images obtained from the fisheye lenses respectively to the top-view projection by using adjusted intermediate extrinsic parameters.

11. The method to fine-tune the extrinsic parameters of the fisheye lens as claimed in claim 1, further comprising:
selecting any one vehicle for initial extrinsic parameter calibration, and the results obtained may be used for multiple other vehicles of the same model.

12. The method to fine-tune the extrinsic parameters of the fisheye lens as claimed in claim 1, further comprising:
fine-tuning the extrinsic parameters of a fisheye lens eliminates the need for strict and precise checkerboard placement or measuring the distance between two checkerboards.

13. A system to fine-tune extrinsic parameters of a fisheye lens applied to surround-view stitching, comprising:
multiple fisheye lenses, configured to obtain fisheye images respectively;
wherein both sides of the fisheye images contain calibration boards;
a processor, electrically connected to the fisheye lenses, configured to:
obtain the fisheye images from the fisheye lenses;
obtain initial extrinsic parameters based on the fisheye images;
detect multiple corner points of the calibration boards in the fisheye images;
arrange the corner points so that the corner points are connected into a quadrilateral in sequence;
multiply the initial extrinsic parameters by a fine-tuning value to obtain intermediate extrinsic parameters;
project the corner points to a top-view projection by using the intermediate extrinsic parameters; and
adjust the intermediate extrinsic parameters according to the shape, size, and overlapping effect of the area surrounded by the corner points in the top-view projection.

14. The system to fine-tune the extrinsic parameters of the fisheye lens as claimed in claim 13, wherein the processor executes a calibration-board corner-point detection algorithm to detect the corner points of the calibration boards in the fisheye images and to arrange the corner points, so that the corner points are connected into a quadrilateral in sequence.

15. The system to fine-tune the extrinsic parameters of the fisheye lens as claimed in claim 13, wherein the processor executes extrinsic-parameter fine-tuning to multiply the initial extrinsic parameters by the fine-tuning value to obtain the intermediate extrinsic parameters, and to adjust the intermediate extrinsic parameters according to the shape, the size, and the overlapping effect of the area surrounded by the corner points in the top-view projection.

16. The system to fine-tune the extrinsic parameters of the fisheye lens as claimed in claim 13, wherein the processor executes surround-view stitching to project the corner points to the top-view projection by using the intermediate extrinsic parameters.

17. The system to fine-tune the extrinsic parameters of the fisheye lens as claimed in claim 13, wherein the processor adjusts a first parameter group among the intermediate extrinsic parameters of the fisheye lenses respectively according to the shape and the size of the calibration boards in the top-view projection, and jointly adjusts a second parameter group among the extrinsic parameters of the fisheye lenses according to the overlapping effect of the calibration boards in a common viewing area of adjacent fisheye lenses in the top-view projection.

18. The system to fine-tune the extrinsic parameters of the fisheye lens as claimed in claim 17, wherein the first parameter group comprises a pitch angle, a yaw angle, and a zoom value.

19. The system to fine-tune the extrinsic parameters of the fisheye lens as claimed in claim 17, wherein the second parameter group comprises a roll angle, a horizontal offset value, and a vertical offset value.

20. The system to fine-tune the extrinsic parameters of the fisheye lens as claimed in claim 13, wherein the processor executes a surround-view stitching algorithm to project the fisheye images obtained from the fisheye lenses respectively to the top-view projection by using adjusted intermediate extrinsic parameters.
